(19) United States
(12) Patent Application Publication
(10) Pub. No.: US 2018/0039242 A1
(43) Pub. Date: Feb. 8, 2018

(54) HIL SIMULATION SYSTEM AND CONTROL METHOD OF THE SAME

(71) Applicant: RENESAS ELECTRONICS CORPORATION, Tokyo (JP)

(72) Inventors: Takashi HIGUCHI, Tokyo (JP); Hitoshi SUZUKI, Tokyo (JP)

(21) Appl. No.: 15/662,624

(22) Filed: Jul. 28, 2017

(30) Foreign Application Priority Data
Aug. 3, 2016 (JP) 2016-152701

(51) Int. Cl. G05B 17/02

(52) U.S. Cl. CPC G05B 17/02

(57) ABSTRACT

An HIL simulation system includes: an arithmetic device executing an input process of receiving input data transferred from software to a memory and an output process of transferring output data to the memory; an operation state designating unit designating an operation state indicating the number of times of the output process to the number of times of the input process of the arithmetic device based on an input time unit as an interval in which the software transfers input data to the memory and an output time unit as an interval in which the software receives output data transferred from the arithmetic device to the memory; and a plurality-of-times execution control unit controlling the number of times of the input process and the output process of the arithmetic device and controlling stop of the arithmetic device based on the operation state designated by the operation state designating unit.

### CROSS-REFERENCE TO RELATED APPLICATIONS

The disclosure of Japanese Patent Application No. 2016-152701 filed on Aug. 3, 2016 including the specification, drawings and abstract is incorporated herein by reference in its entirety.

### BACKGROUND

The present invention relates to an HIL (Hardware In the Loop) simulation system and a control method of the same and can be suitably used for, for example, an HIL simulation system in which data is input/output between software and an arithmetic device via a memory.

An embedded system of directly controlling hardware by a microcomputer is known. An example of an embedded system is a system of controlling real hardware (engine, motor, sensor, or the like) by an ECU (Engine Control Unit) of a car. In a test of an arithmetic device of an ECU or the like, an HIL simulation system using software performing simulation by using a mathematical expression of an operation characteristic of real hardware in place of real hardware to be controlled by the arithmetic device is often used (for example, Japanese Unexamined Patent Application Publication No. 2011-054129).

### SUMMARY

An HIL simulation system has, generally, a configuration of driving an arithmetic device for an event generated on the software side. Consequently, for example, a system is embedded so that an input event is generated on the software side and, as a response to input data supplied from the software to an arithmetic device in the input event, the arithmetic device sends output data to the software side.

With increase in the speed of an ECU system in recent years, a problem occurs such that when an ECU is operated at high speed without obtaining synchronization with a mathematics expression of software, the difference between an actual hardware characteristic and a calculation result occurs and, on the other hand, when transfer is performed each time all of processes are performed in accordance with the mathematics express of the software and finest events of input and output, the process time of the entire system becomes long, and the system process speed becomes slow.

The other problems and novel features will become apparent from the description of the present specification and the appended drawings.

According to an embodiment, an HIL simulation system designates an operation state indicating the number of times of an output process to the number of times of an input process of an arithmetic device on the basis of an input time unit and an output time unit of software, on the basis of the designated operation state, controls the number of times of the input process and the output process of the arithmetic device, and controls stop of the operation of the arithmetic device.

The embodiment can contribute to solve the above-described problem.

### BRIEF DESCRIPTION OF THE DRAWINGS

FIG. 1 is a diagram illustrating an outline configuration example of a general HIL simulation system.

FIG. 2 is a diagram illustrating an example of an input time unit and an output time unit of real hardware.

FIG. 3 is a block diagram illustrating a configuration example of an HIL simulation system as a conventional example.

FIG. 4 is a timing chart illustrating an operation example of the HIL simulation system as the conventional example.

FIG. 5 is a timing chart illustrating an operation example of the HIL simulation system as the conventional example.

FIG. 6 is a block diagram illustrating a configuration example of an HIL simulation system according to a first embodiment.

FIG. 7 is a timing chart illustrating an operation example of the HIL simulation system according to the first embodiment.

FIG. 8 is a timing chart illustrating an operation example of the HIL simulation system according to the first embodiment.

FIG. 9 is a block diagram illustrating a configuration example of an HIL simulation system according to a second embodiment.

FIG. 10 is a timing chart illustrating an operation example of the HIL simulation system according to the second embodiment.

FIG. 11 is a block diagram illustrating a configuration example of an HIL simulation system according to a third embodiment.

FIG. 12 is a timing chart illustrating an operation example of the HIL simulation system according to the third embodiment.

### DETAILED DESCRIPTION

Prior to description of embodiments, first, matters as preconditions of the embodiments will be described. For clarification of description, omission and simplification are properly made in the following description and drawings. The part of hardware in elements illustrated in the drawings as function blocks performing various processes can be constructed by a CPU (Central Processing Unit), a memory, and other circuits, and the part of software is realized by a program loaded to a memory and the like. Therefore, a person skilled in the art understands that the function blocks can be realized in various forms of only hardware, only software, or combination of the hardware and software, and the invention is not limited to any of the forms. In the drawings, the same reference numeral is designated to the same element and repetitive description is omitted as necessary.

The above-descried program is stored by using any of non-transitory computer readable media of various types and can be supplied to a computer. The non-transitory computer readable media include tangible storage media of various types. Examples of the non-transitory computer readable media include magnetic recording media (for example, flexible disk, magnetic tape, and hard disk drive), magnet-optic recording media (for example, magnet-optic disk), CD-ROM (Read Only Memory), CD-R, CD-R/W, and semiconductor memories (for example, mask ROM, PROM (Programmable ROM), EPROM (Erasable PROM), flash ROM, and RAM (Random Access Memory)). The program may be supplied to a computer by any of transitory computer readable media of various types. Examples of the transitory computer readable media include an electric signal, an optical signal, and electromagnetic wave. The transitory computer readable medium can supply a program to a computer via a wired communication path such as an electric wire or an optical fiber or a wireless communication path.

### Outline of HIL Simulation System

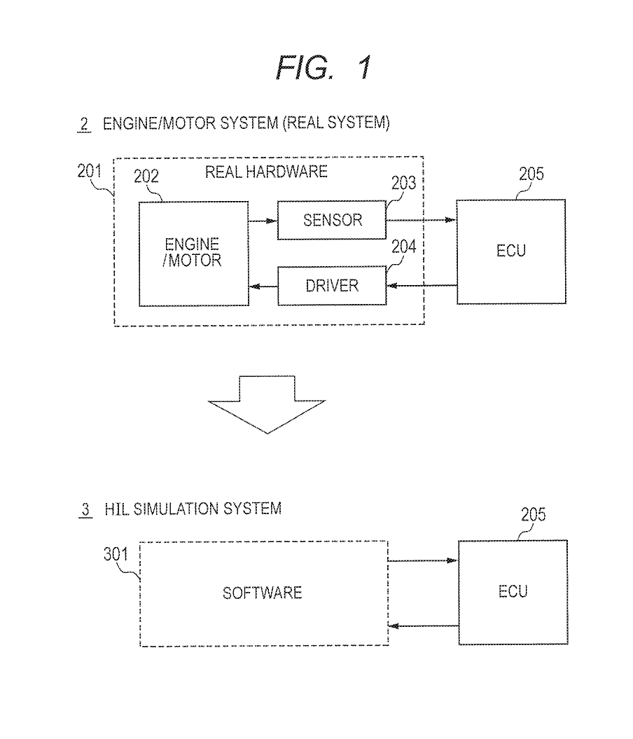

First, referring to FIG. 1, the outline configuration of a common HIL simulation system 3 will be described. FIG. 1 illustrates, as an example, the case where a real system which is simulated by the HIL simulation system 3 is an engine/motor system 2 of a car.

As illustrated in FIG. 1, the engine/motor system 2 has real hardware 201 made by an engine/motor 202, a sensor 203, and a driver 204, and an ECU 205.

The real hardware 201 detects the state of the engine/motor 202 (for example, the rotational speed of the motor) by the sensor 203 and transfers a sensor result as the detection result as input data to the ECU 205. The ECU 205 generates a control signal for controlling the driver 204 on the basis of the sensor result transferred as input data from the real hardware 201 and transfers the generated control signal as output data to the real hardware 201. The real hardware 201 drives the engine/motor 202 by the driver 204 on the basis of the control signal transferred as the output data from the ECU 205.

A part obtained by replacing the part of the real hardware 201 in the engine/motor system 2 to software 301 performing simulation by using a mathematical expression of the operation characteristic of the real hardware 201 corresponds to the HIL simulation system 3. Specifically, the software 301 has therein a physical model which is obtained by modeling the part of the real hardware 201 and simulates the operation characteristic of the real hardware 201 by using the physical model.

In the actual real system, a memory is arranged between the real hardware and the ECU, and data is input/output via the memory between the real hardware and the ECU. Concretely, the real hardware transfers input data to the memory, and the ECU receives the input data from the memory. The ECU transfers output data to the memory, and the real hardware receives the output data from the memory.

In the real hardware, an input time unit and an output time unit are defined. The input time unit is an interval in which the real hardware transfers input data, and the output time unit is an interval in which the real hardware receives output data from the memory. However, in the real hardware, there is the case that the input time unit and the output time unit are different from each other.

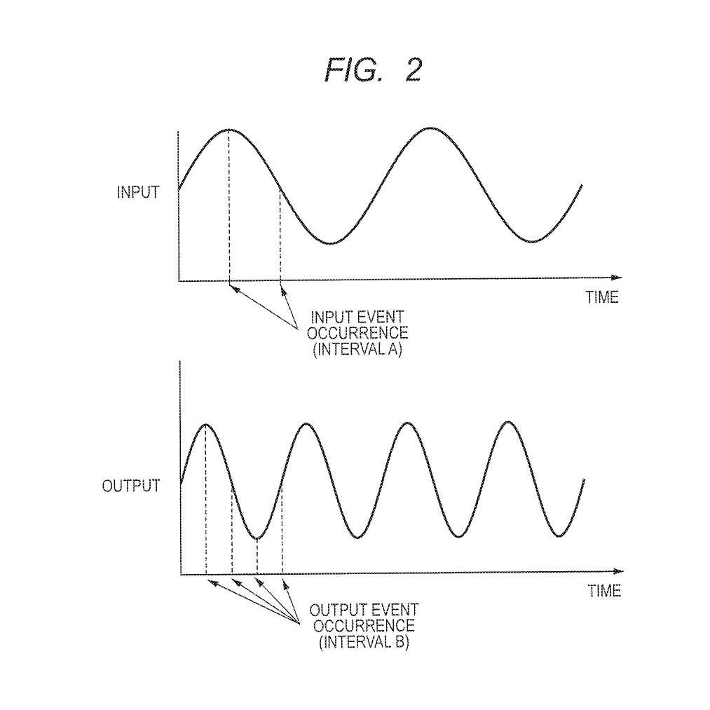

For example, in the example illustrated in FIG. 2, an input event that the real hardware transfers input data to the memory occurs in an interval A. On the other hand, an output event that the real hardware receives output data from the memory occurs in an interval B which is shorter than the interval A. That is, in the example illustrated in FIG. 2, the input time unit is longer than the output time unit.

In the HIL simulation system, the behavior of the real hardware and that of operation have to be made coincided. Consequently, in the case where the input time unit and the output time unit of real software are different from each other, in accordance with the case, the input time unit and the output time unit have to be made different also in software. The HIL simulation system is required to also shorten the process time of the entire system.

### Configuration of HIL Simulation System According to Comparison Example

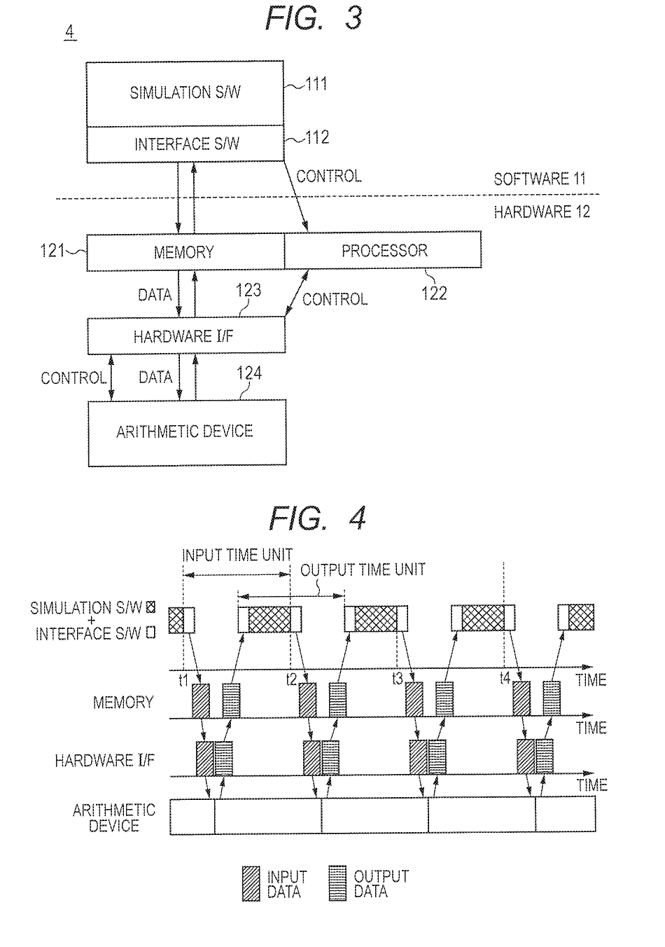

Next, referring to FIG. 3, the configuration of an HIL simulation system 4 according to a comparison example examined by the inventors of the present invention and the like in advance will be described.

As illustrated in FIG. 3, the HIL simulation system 4 according to the comparison example includes, as software 11, simulation S/W (software) 111 and interface S/W (software) 112 and includes, as hardware 12, a memory 121, a processor 122, a hardware I/F (interface) 123, and an arithmetic device 124.

The simulation S/W 111 is software having therein a physical model obtained by modeling real hardware and simulating the operation characteristic of the real hardware by using the physical model.

The interface S/W 112 is software which transfers and writes input data transferred from the simulation S/W 111 to the memory 121, reads and receives output data from the memory 121, and transfers the received output data to the simulation S/W 111.

The simulation S/W 111 and the interface S/W 112 are executed by the processor 122.

To/from the memory 121, input data is written and output data is read.

The processor 122 reads the input data written in the memory 121 by the interface S/W 112 and transfers the read input data to the hardware I/F 123. The processor 122 writes output data transferred from the hardware I/F 123 to the memory 121. The processor 122 is an example of a transfer unit.

The hardware I/F 123 transfers the input data transferred from the processor 122 to the arithmetic device 124 and transfers the output data transferred from the arithmetic device 124 to the memory 121. The hardware I/F 123 is, for example, an interface board controlling DMA (Direct Memory Access) transfer to the memory 121 and transfer to the arithmetic device 124 or a controller accompanying the arithmetic device 124.

The arithmetic device 124 performs an input process of receiving input data transferred from the memory 121 via the hardware I/F 123. The arithmetic device 124 performs an output process of transferring output data generated on the basis of the input data to the memory 121 via the hardware I/F 123. The arithmetic device 124 is, for example, an ECU of a car or the like.

### Operation of HIL Simulation System According to Comparison Example

Next, referring to FIG. 4, the operation of the HIL simulation system 4 according to the comparison example will be described.

As described above, the HIL simulation system 4 has generally a configuration that the arithmetic device 124 is driven for an event which occurs on the software 11 side. Consequently, in the example illustrated in FIG. 4, the system is embedded so that an input event is generated at times t1, t2, t3, and t4 on the software 11 side and, as a response to input data received in the input events, the arithmetic device 124 sends output data to the software 11 side.

However, in the example illustrated in FIG. 4, the arithmetic device 124 performs processes since output data is transferred until input data is received by low-speed operation in accordance with the operation on the side of the software 11 whose process speed is low. As a result, a problem occurs such that the process time of the HIL simulation system 4 as a whole becomes long.

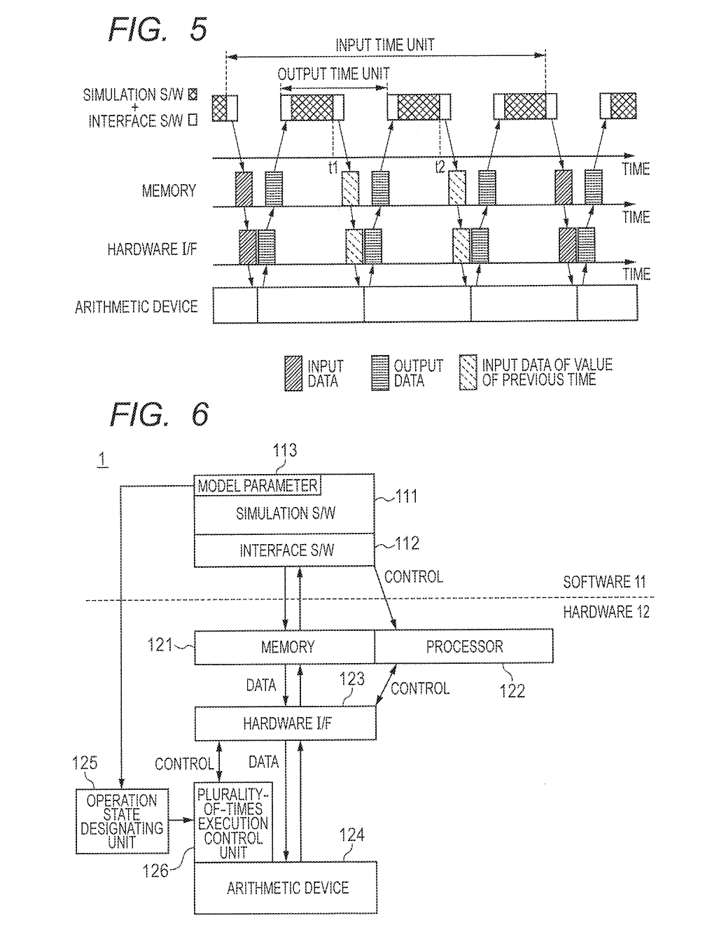

FIG. 4 illustrates an example that the input time unit as the interval that the simulation S/W 111 transfers input data to the memory 121 and the output time unit as the interval that the simulation S/W 111 receives output data from the memory 121 are the same. However, in the case where the input time unit and the output time unit of the simulation S/W 111 are different, a problem occurs such that the process time of the entire system becomes longer. The problem will be described with reference to FIG. 5.

When the input time unit and the output time unit of the simulation S/W 111 are different, the HIL simulation system 4 performs the input/output process in accordance with the minimum time unit. In the example illustrated in FIG. 5, the output time unit is the minimum time unit. Consequently, the HIL simulation system 4 performs the input/output process in accordance with the output time unit. Due to this, a useless transfer process of transferring input data of the value of the previous time which is unnecessary for the real hardware is executed at the times t1 and t2. As a result, a problem occurs such that the process time of the HIL simulation system 4 as a whole becomes longer.

In the example illustrated in FIG. 5, since updating of the input data of the value of the previous time is unnecessary, there is also a problem such that the arithmetic device 124 has to obtain synchronization of transfer timings between the simulation S/W 111 and the arithmetic device 124.

Each of the embodiments to be described hereinafter solves the problems as described above by controlling the operation of the arithmetic device 124 on the basis of the input time unit and the output time unit of the simulation S/W 111.

### First Embodiment

Hereinbelow, a first embodiment will be described.

### Configuration of First Embodiment

First, referring to FIG. 6, the configuration of the HIL simulation system 1 according to a first embodiment will be described. As illustrated in FIG. 6, the HIL simulation system 1 according to the first embodiment has a configuration that, as compared to the HIL simulation system 4 according to the comparison example illustrated in FIG. 3, a model parameter 113 is added as the software 11, and an operation state designating unit 125 and a plurality-of-times execution control unit 126 are added as the hardware 12. The operation state designating unit 125 is an example of a designating unit, and the plurality-of-times execution control unit 126 is an example of a control unit.

The model parameter 113 is a parameter of a physical model in the simulation S/W 111. It is assumed that the model parameter 113 refers to at least the input time unit and the output time unit of the simulation S/W 111. The simulation S/W 111 sets the model parameter 113 in the interface S/W 112 and the operation state designating unit 125.

The operation state designating unit 125 designates the operation state indicating the number of times of the output process to the number of times of the input process of the arithmetic device 124 on the basis of the input time unit and the output time unit of the simulation S/W 111 indicated by the model parameter 113. The operation state designating unit 125 notifies the plurality-of-times execution control unit 126 of the operation state of the arithmetic device 124 and notifies the hardware I/F 123 via the plurality-of-times execution control unit 126. The operation state designating unit 125 may be configured so that the operation state of the arithmetic device 124 is fixed or may be configured by, for example, a register so that the operation state of the arithmetic device 124 can be changed.

The plurality-of-times execution control unit 126 controls the number of times of the input process and the output process of the arithmetic device 124 on the basis of the operation state of the arithmetic device 124 designated by the operation state designating unit 125 and controls stop of the operation of the arithmetic device 124. The plurality-of-times execution control unit 126 has the function of turning on/off a clock for the input process and a clock for the output process of the arithmetic device 124 and, by turning on/off the clocks, makes the arithmetic device 124 execute the input process and the output process or stops the operation of the arithmetic device 124. The plurality-of-times execution control unit 126 starts operating under control of the hardware I/F 123.

The operation state designating unit 125 and the plurality-of-times execution control unit 126 will be described more specifically. In the specification, it is assumed as follows. When the input time unit of the simulation S/W 111 is longer than the output time unit, the ratio between the input time unit and the output time unit is N:1 (N is a natural number of two or larger). When the output time unit of the simulation S/W 111 is longer than the input time unit, the ratio between the input time unit and the output time unit is 1:N (N is a natural number of two or larger).

First, the case where the input time unit of the simulation S/W 111 is longer than the output time unit and the model parameter 113 indicates that the ratio between the input time unit and the output time unit is N:1 is considered. In this case, the operation state designating unit 125 designates the operation state when the ratio between the number of times of the input process and the number of times of the output process of the arithmetic device 124 is 1:N. In this case, the plurality-of-times execution control unit 126 makes the arithmetic device 124 execute N times of output processes subsequent to the input process of once and, after that, stops the operation of the arithmetic device 124.

Subsequently, the case where the output time unit of the simulation S/W 111 is longer than the input time unit and the model parameter 113 indicates that the ratio between the input time unit and the output time unit is 1:N is considered. In this case, the operation state designating unit 125 designates the operation state that the ratio between the number of times of the input process and the number of times of the output process of the arithmetic device 124 is N:1. In this case, the plurality-of-times execution control unit 126 makes the arithmetic device 124 execute the output process of once subsequent to the N times of input processes and, each time the output process and the first to the (N−1)th input processes are executed, stops the operation of the arithmetic device 124.

### Operation of First Embodiment

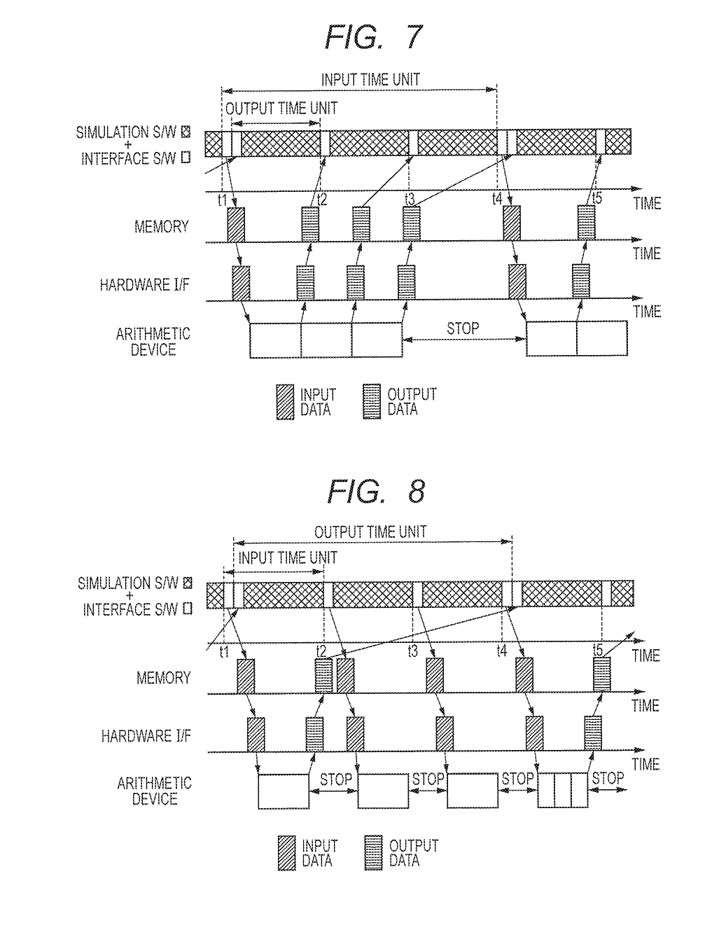

Hereinbelow, referring to FIGS. 7 and 8, the operation of the HIL simulation system 1 according to the first embodiment will be described.

Operation in the Case where Input Time Unit is Longer than Output Time Unit

First, referring to FIG. 7, the operation in the case where the input time unit of the simulation S/W 111 is longer than the output time unit will be described. In the example illustrated in FIG. 7, “the ratio between the input time unit and the output time unit is 3:1” and it is indicated by the model parameter 113. Consequently, it is assumed that the operation state designating unit 125 designates, as the operation state of the arithmetic device 124, the operation state that “the ratio between the number of times of the input process and the number of times of the output process is 1:3”.

When an event trigger by time is received at time t1, the simulation S/W 111 calls the interface S/W 112. The interface S/W 112 determines the content of the event on the basis of the model parameter 113. In the example illustrated in FIG. 7, the model parameter 113 indicates that “the ratio between the input time unit and the output time unit is 3:1”, so that the output event is generated by an event trigger of each time, and the input event is generated once for three times of event triggers.

The interface S/W 112 determines that both an output event and an input event are generated at the time t1. Consequently, first, the interface S/W 112 makes an input event generated, transfers input data transferred from the simulation S/W 111 to the memory 121, and writes it into the memory 121. The processor 122 reads the input data from the memory 121 and transfers it to the hardware I/F 123 under control of the interface S/W 112. The hardware I/F 123 transfers the input data transferred from the processor 122 to the arithmetic device 124 under control of the processor 122. After completion of the transfer of the input data to the memory 121, the interface S/W 112 generates an output event, reads and receives output data written in the memory 121 by a previous process, and transfers the output data to the simulation S/W 111.

When the input data is transferred from the hardware I/F 123, the plurality-of-times execution control unit 126 checks the operation state of the arithmetic device 124 designated by the operation state designating unit 125. In this case, the operation state that “the ratio between the number of times of input process and the number of times of output process is 1:3” is designated. Consequently, the plurality-of-times execution control unit 126 makes the arithmetic device 124 execute the input process of receiving the input data transferred from the hardware I/F 123 once and, after that, makes the arithmetic device 124 execute the output process of transferring output data to the hardware I/F 123 three times. After completion of the output process of the three times, the plurality-of-times execution control unit 126 stops the operation of the arithmetic device 124. Each time the arithmetic device 124 performs the output process, the hardware I/F 123 transfers the output data transferred from the arithmetic device 124 to the memory 121, and the processor 122 writes the output data transferred from the hardware I/F 123 to the memory 121 under control of the hardware I/F 123.

When the next event trigger by time is received at time t2, the simulation S/W 111 calls the interface S/W 112. The interface S/W 112 determines the content of the event on the basis of the model parameter 113. At time t2, the interface S/W 112 determines that only an output event is generated. Consequently, the interface S/W 112 makes an output event generated, reads and receives output data written in the memory 121 by a previous process, and transfers the output data to the simulation S/W 111.

Hereinafter, at times t3 and t5, a process similar to the process at time t2 is performed. At time t4, a process similar to the process at time t1 is performed.

That is, in the example illustrated in FIG. 7, for example, in the input event generated at time t1, the interface S/W 112 transfers the input data transferred from the simulation S/W 111 to the memory 121, and the arithmetic device 124 receives the input data from the memory 121. In response to the reception of the input data, the arithmetic device 124 transfers three pieces of output data to the memory 121 and, after that, stops the operation. The three pieces of output data transferred to the memory 121 are supplied to the interface S/W 112 at output events generated at the following times t2, t3, and t4 and transferred to the simulation S/W 111.

Operation in the Case where Output Time Unit is Longer than Input Time Unit

Next, referring to FIG. 8, the operation in the case where the output time unit of the simulation S/W 111 is longer than the input time unit will be described. In the example illustrated in FIG. 8, “the ratio between the input time unit and the output time unit is 1:3” and it is indicated by the model parameter 113. Consequently, it is assumed that the operation state designating unit 125 designates, as the operation state of the arithmetic device 124, the operation state that “the ratio between the number of times of the input process and the number of times of the output process is 3:1”.

When an event trigger by time is received at time t1, the simulation S/W 111 calls the interface S/W 112. The interface S/W 112 determines the content of the event on the basis of the model parameter 113. In the example illustrated in FIG. 8, the model parameter 113 indicates that “the ratio between the input time unit and the output time unit is 1:3”, so that the input event is generated by an event trigger of each time, and the output event is generated once for three times of event triggers.

The interface S/W 112 determines that both an input event and an output event are generated at the time t1. Consequently, first, the interface S/W 112 makes an input event generated, transfers input data transferred from the simulation S/W 111 to the memory 121, and writes it into the memory 121. The processor 122 reads the input data from the memory 121 and transfers it to the hardware I/F 123 under control of the interface S/W 112. The hardware I/F 123 transfers the input data transferred from the processor 122 to the arithmetic device 124 under control of the processor 122. After completion of the transfer of the input data to the memory 121, the interface S/W 112 generates an output event, reads and receives output data written in the memory 121 by a previous process, and transfers the output data to the simulation S/W 111.

When the input data is transferred from the hardware I/F 123, the plurality-of-times execution control unit 126 checks the operation state of the arithmetic device 124 designated by the operation state designating unit 125. In this case, the operation state that “the ratio between the number of times of the input process and the number of times of the output process is 3:1” is designated. Consequently, the plurality-of-times execution control unit 126 makes the arithmetic device 124 execute the input process of receiving the input data transferred from the hardware I/F 123 once. The plurality-of-times execution control unit 126 determines whether the arithmetic device 124 is made execute the input process three times in a row. In this case, the plurality-of-times execution control unit 126 determines that the input process is executed three times in a row, subsequently, makes the arithmetic device 124 execute the output process of transferring output data to the hardware I/F 123 once, and after completion of the output process, stops the operation of the arithmetic device 124. When the arithmetic device 124 performs the output process, the hardware I/F 123 transfers the output data transferred from the arithmetic device 124 to the memory 121, and the processor 122 writes the output data transferred from the hardware I/F 123 to the memory 121 under control of the hardware I/F 123.

When the next event trigger by time is received at time t2, the simulation S/W 111 calls the interface S/W 112. The interface S/W 112 determines the content of the event on the basis of the model parameter 113. At time t2, the interface S/W 112 determines that only an input event is generated. Consequently, the interface S/W 112 makes an input event generated, transfers the input data transferred from the simulation S/W 111 to the memory 121, and writes it in the memory 121. The processor 122 reads the input data from the memory 121 and transfers it to the hardware I/F 123 under control of the interface S/W 112. The hardware I/F 123 transfers the input data transferred from the processor 122 to the arithmetic device 124 under control of the processor 122.

When the input data is transferred from the hardware I/F 123, the plurality-of-times execution unit 126 checks the operation state of the arithmetic device 124 designated by the operation state designating unit 125 and, first, makes the arithmetic device 124 execute an input process of receiving the input data transferred from the hardware I/F 123 once. The plurality-of-times execution control unit 126 determines whether the arithmetic device 124 is made execute the input process three times in a row or not. In this case, the plurality-of-times execution control unit 126 determines that the input process is not executed three times in a row and, after completion of the input process, stops the operation of the arithmetic device 124.

Hereinafter, at times t3 and t5, a process similar to the process at time t2 is performed. At time t4, a process similar to the process at time t1 is performed.

That is, in the example illustrated in FIG. 8, for example, in the input events generated at times t2, t3, and t4, the interface S/W 112 transfers the input data transferred from the simulation S/W 111 to the memory 121, and the arithmetic device 124 receives the input data from the memory 121. Consequently, the arithmetic device 124 receives three pieces of input data in total. After the first and second pieces of input data are received, the arithmetic device 124 stops the operation. In response to reception of the third piece of the input data, the arithmetic device 124 transfers output data to the memory 121 and, after that, stops the operation. The output data transferred to the memory 121 is supplied to the interface S/W 112 in an output event generated afterwards and transferred to the simulation S/W 111.

### Effects of First Embodiment

As described above, according to the first embodiment, the operation state designating unit 125 designates the operation state indicating the number of times of the output process to the number of times of the input process of the arithmetic device 124 on the basis of the input time unit and the output time unit of the simulation S/W 111 indicated by the model parameter 113, and the plurality-of-times execution control unit 126 controls the number of times of the input process and the output process of the arithmetic device 124 and controls stop of the operation of the arithmetic device 124 on the basis of the operation state designated by the operation state designating unit 125.

By the above, the number of times of the input process and the output process of the arithmetic device 124 can be properly controlled so that occurrence of the useless transfer process of transferring input data of the value of a previous time can be avoided. By properly controlling the number of times of the input process and the output process of the arithmetic device 124, the operation of the arithmetic device 124 can be stopped other than the time in which the input process and the output process are executed. Since the operation of the arithmetic device 124 is stopped, the arithmetic device 124 does not have to operate at low speed in accordance with the operation of the simulation S/W 111 and can perform the input process and the output process at high speed. As a result of the above, the process time of the HIL simulation system 1 as a whole can be shortened.

Since the operation of the arithmetic device 124 is stopped, the transfer timing of the simulation S/W 111 and that of the arithmetic device 124 can be synchronized. By forming a library of the interface S/W 112, the user of the HIL simulation system 1 can make optimum hardware setting without being aware of an actual process.

### Second Embodiment

Subsequently, a second embodiment will be described.

In the first embodiment, when the process speed of the arithmetic device 124 is very fast as compared with the process speed of the simulation S/W 111, in some cases, the transfer speed of the simulation S/W 111 and that of the hardware I/F 123 compete against each other in the memory 121, and the process of the simulation S/W 111 is delayed only by the amount.

In the second embodiment, by decreasing the number of times that the transfer process of input data from the simulation S/W 111 and that of input data to the hardware I/F 123 compete against each other in the memory 121, the number of times that the process of the simulation S/W 111 delays is decreased.

### Configuration of Second Embodiment

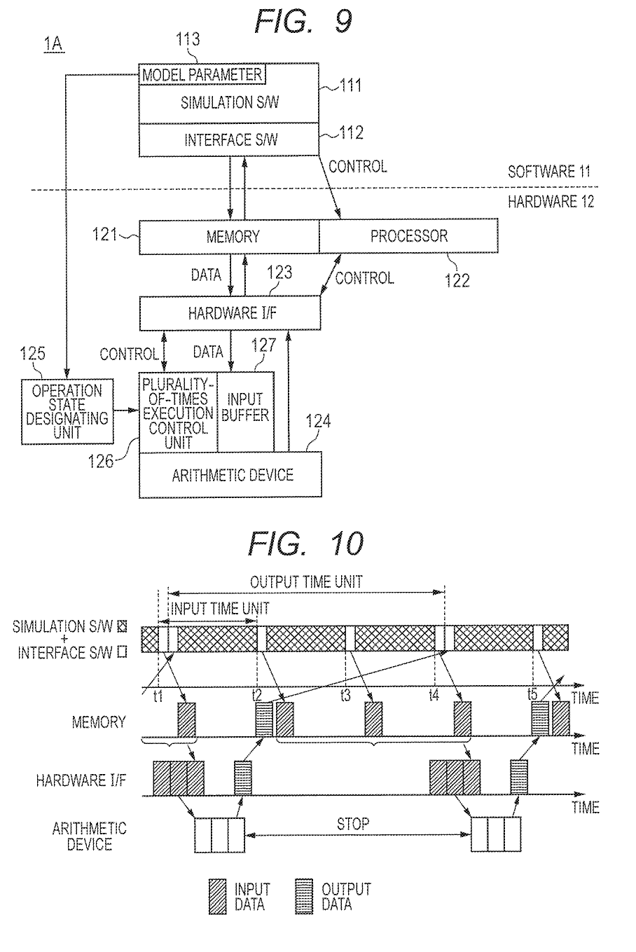

First, referring to FIG. 9, the configuration of an HIL simulation system 1A according to the second embodiment will be described.

As illustrated in FIG. 9, the HIL simulation system 1A according to the second embodiment has a configuration obtained by adding an input buffer 127 as the hardware 12 to the HIL simulation system 1 according to the first embodiment illustrated in FIG. 6.

The input buffer 127 is a buffer provided in the interface part of the arithmetic device 124 and temporarily storing input data before the arithmetic device 124 receives the input data. The input buffer 127 is provided for burst-transferring a plurality of pieces of input data in a lump from the memory 121 to the arithmetic device 124. The transfer burst length at this time is set on the basis of the input time unit and the output time unit of the simulation S/W 111 indicated by the model parameter 113 so that a plurality of pieces of input data can be transferred in a lump.

### Operation of Second Embodiment

Next, referring to FIG. 10, the operation of the HIL simulation system 1A according to the second embodiment will be described. In the example illustrated in FIG. 10, the output time unit of the simulation S/W 111 is longer than the input time unit. Concretely, in the example illustrated in FIG. 10, “the ratio between the input time unit and the output time unit is 1:3” and it is indicated by the model parameter 113. It is therefore assumed that the operation state designating unit 125 designates the operation state that “the ratio between the number of times of the input process and the number of times of the output process is 3:1” as the operation state of the arithmetic device 124. It is also assumed that the transfer burst length at the time of burst-transferring input data from the memory 121 to the arithmetic device 124 is set to the burst length of the amount of three pieces of input data.

When the event trigger by time is received at time t1, the simulation S/W 111 calls the interface S/W 112. The interface S/W 112 determines the content of the event on the basis of the model parameter 113. In the example illustrated in FIG. 10, the model parameter 113 indicates that “the ratio between the input time unit and the output time unit is 1:3”, so that an input event is generated at an event trigger of each time, and an output event is generated once for three event triggers.

The interface S/W 112 determines that both an input event and an output event are generated at time t1. Consequently, the interface S/W 112 makes an input event generated, transfers input data from the simulation S/W 111 to the memory 121, and writes it into the memory 121. Subsequently, the interface S/W 112 determines whether the number of pieces of input data transferred to the memory 121 becomes three which corresponds to the transfer burst length. In this case, the interface S/W 112 determines that the number of pieces of input data transferred to the memory 121 becomes three. Therefore, the processor 122 reads the three pieces of input data from the memory 121 and burst-transfers it to the hardware I/F 123 under control of the interface S/W 112. The hardware I/F 123 burst-transfers the three pieces of input data transferred from the processor 122 to the arithmetic device 124 under control of the processor 122. At this time, since the arithmetic device 124 cannot process the three pieces of input data at once, the three pieces of input data are temporarily stored in the input buffer 127. After completion of transfer of the input data to the memory 121, the interface S/W 112 makes an output event generated, reads and receives output data written in the memory 121 by a previous process, and transfers it to the simulation S/W 111.

When the three pieces of input data transferred from the hardware I/F 123 are stored in the input buffer 127, the plurality-of-times execution control unit 126 checks the operation state of the arithmetic device 124 designated by the operation state designating unit 125. In this case, the operation state that “the ratio between the number of times of the input process and the number of times of the output process is 3:1” is designated. Consequently, the plurality-of-times execution control unit 126 makes the arithmetic device 124 execute the input process of receiving each of the three pieces of input data stored in the input buffer 127 three time and execute the output process of transferring output data to the hardware I/F 124 once and, after completion of the output process, stops the operation of the arithmetic device 124. When the arithmetic device 124 performs the output process, the hardware I/F 123 transfers output data transferred from the arithmetic device 124 to the memory 121, and the processor 122 writes the output data transferred from the hardware I/F 123 into the memory 121 under control of the hardware I/F 123.

When the next event trigger by time is received at time t2, the simulation S/W 111 calls the interface S/W 112. The interface S/W 112 determines the content of the event on the basis of the model parameter 113. At time t2, the interface S/W 112 determines that only an input event is generated. Consequently, the interface S/W 112 makes an input event generated, transfers input data transferred from the simulation S/W 111 to the memory 121, and writes it into the memory 121. Subsequently, the interface S/W 112 determines whether the number of pieces of input data transferred to the memory 121 becomes three which corresponds to the transfer burst length or not. In this case, the interface S/W 112 determines that the number of pieces of the input data transferred to the memory 121 is not three. Therefore, at this time point, the input data is not transferred to the hardware I/F 123. At the time point when the number of pieces of input data becomes three in the memory 121, the three pieces of input data are burst-transferred to the hardware I/F 123.

Hereinafter, at times t3 and t5, a process similar to the process at time t2 is performed. At time t4, a process similar to the process at time t1 is performed.

That is, in the example illustrated in FIG. 10, for example, in the input events generated at times t2, t3, and t4, the interface S/W 112 transfers the input data transferred from the simulation S/W 111 to the memory 121, and, after three pieces of input data are transferred to the memory 121, the processor 122 burst-transfers the three pieces of input data to the arithmetic device 124. The arithmetic device 124 temporarily stores the three pieces of input data into the input buffer 127 and receives the three pieces of input data one by one from the input buffer 127. In response to reception of the three pieces of input data, the arithmetic device 124 transfers output data to the memory 121 and, after that, stops the operation. The output data transferred to the memory 121 is supplied to the interface S/W 112 at output events generated afterwards and transferred to the simulation S/W 111.

### Effects of Second Embodiment

As described above, according to the second embodiment, as the input buffer 127 is added in the interface part of the arithmetic device 124, when a plurality of pieces of input data are transferred from the memory 121 to the arithmetic device 124, the plurality of pieces of input data can be temporarily stored in the input buffer 127. Consequently, when the output time unit of the simulation S/W 111 is longer than the input time unit, the plurality of pieces of input data are burst-transferred in a lump from the memory 121 to the arithmetic device 124.

By the above, the number of times that the process of transferring input data from the simulation S/W 111 and the process of transferring input data to the hardware I/F 123 compete against each other in the memory 121 decreases. As a result, the number of times that the process of the simulation S/W 111 delays can be decreased, so that the process time of the HIL simulation system 1A as a whole can be further shortened.

### Third Embodiment

Subsequently, a third embodiment will be described.

In the first embodiment, when the process speed of the arithmetic device 124 is very fast as compared with the process speed of the simulation S/W 111, in some cases, the transfer process of the simulation S/W 111 and that of the hardware I/F 123 compete against each other in the memory 121. Consequently, the process of the simulation S/W 111 is delayed only by the amount.

In the third embodiment, by decreasing the number of times that the transfer process of output data to the simulation S/W 111 and that of output data to the hardware I/F 123 compete against each other in the memory 121, the number of times that the process of the simulation S/W 111 delays is decreased.

### Configuration of Third Embodiment

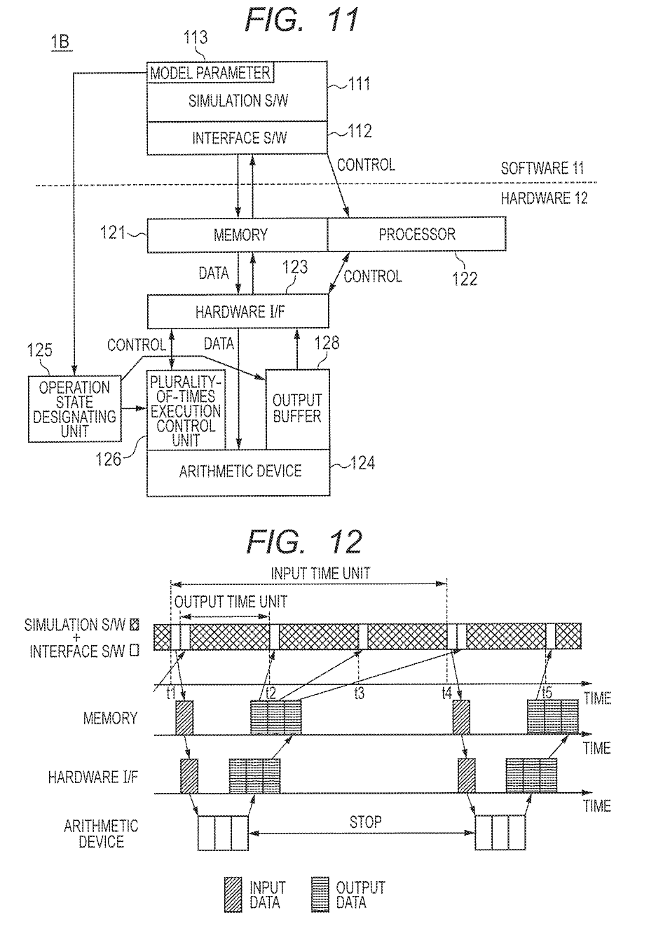

First, referring to FIG. 11, the configuration of an HIL simulation system 1B according to a third embodiment will be described.

As illustrated in FIG. 11, the HIL simulation system 1B according to the third embodiment has a configuration obtained by adding an output buffer 128 as the hardware 12 to the HIL simulation system 1 according to the first embodiment illustrated in FIG. 6.

The output buffer 127 is a buffer provided in the interface part of the arithmetic device 124 and temporarily storing output data from the arithmetic device 124. The output buffer 128 is provided for burst-transferring a plurality of pieces of output data in a lump from the arithmetic device 124 to the memory 121. The transfer bust length at this time is set on the basis of the operation state of the arithmetic device 124 designated by the operation state designating unit 125 so that a plurality of pieces of output data can be transferred in a lump.

### Operation of Third Embodiment

Next, referring to FIG. 12, the operation of the HIL simulation system 1B according to the third embodiment will be described. In the example illustrated in FIG. 12, the input time unit of the simulation S/W 111 is longer than the output time unit. Concretely, in the example illustrated in FIG. 12, “the ratio between the input time unit and the output time unit is 3:1” and it is indicated by the model parameter 113. It is therefore assumed that the operation state designating unit 125 designates the operation state that “the ratio between the number of times of the input process and the number of times of the output process is 1:3” as the operation state of the arithmetic device 124. It is also assumed that the transfer burst length at the time of burst-transferring output data from the arithmetic device 124 to the memory 121 is set to the burst length of the amount of three pieces of output data.

When the event trigger by time is received at time t1, the simulation S/W 111 calls the interface S/W 112. The interface S/W 112 determines the content of the event on the basis of the model parameter 113. In the example illustrated in FIG. 12, the model parameter 113 indicates that “the ratio between the input time unit and the output time unit is 3:1”, so that an output event is generated at an event trigger of each time, and an input event is generated once for three event triggers.

The interface S/W 112 determines that both an output event and an input event are generated at time t1. Consequently, the interface S/W 112 makes an input event generated first, transfers input data transferred from the simulation S/W 111 to the memory 121, and writes it into the memory 121. The processor 122 reads the input data from the memory 121 and transfers it to the hardware I/F 123 under control of the interface S/W 112. The hardware I/F 123 transfers the input data transferred from the processor 122 to the arithmetic device 124 under control of the processor 122. After completion of transfer of the input data to the memory 121, the interface S/W 112 makes an output event generated, reads and receives one piece of output data written in the memory 121 by a previous process, and transfers it to the simulation S/W 111.

When the input data transferred from the hardware I/F 123, the plurality-of-times execution control unit 126 checks the operation state of the arithmetic device 124 designated by the operation state designating unit 125. In this case, the operation state that “the ratio between the number of times of the input process and the number of times of the output process is 1:3” is designated. Consequently, the plurality-of-times execution control unit 126 makes the arithmetic device 124 execute the input process of receiving the input data transferred from the hardware I/F 123 once and, after that, execute an output process of transferring and storing output data to the output buffer 128 three times. After completion of the three times of the output process, the plurality-of-times execution control unit 126 stops the operation of the arithmetic device 124. Each time the arithmetic device 124 performs the output process, the output buffer 128 determines whether the number of pieces of output data transferred to the output buffer 128 becomes three corresponding to the transfer burst length. At the time point the number of pieces of input data transferred to the output buffer 128 becomes three, the output buffer 128 burst-transfers the three pieces of output data in a lump to the hardware I/F 123. The hardware I/F 123 burst-transfers the three pieces of output data transferred from the output buffer 128 to the memory 121, and the processor 122 writes the three pieces of output data transferred from the hardware I/F 123 into the memory 121 under control of the hardware I/F 123.

When the next event trigger by time is received at time t2, the simulation S/W 111 calls the interface S/W 112. The interface S/W 112 determines the content of the event on the basis of the model parameter 113. At time t2, the interface S/W 112 determines that only an output event is generated. Consequently, the interface S/W 112 makes an output event generated, reads and receives one piece of output data written in the memory 121 by a previous process, and transfers it to the simulation S/W 111.

Hereinafter, at times t3 and t5, a process similar to the process at time t2 is performed. At time t4, a process similar to the process at time t1 is performed.

That is, in the example illustrated in FIG. 12, for example, in the input event generated at time t1, the interface S/W 112 transfers the input data transferred from the simulation S/W 111 to the memory 121 and the arithmetic device 124 receives the input data from the memory 121. In response to the reception of the input data, the arithmetic device 124 transfers three pieces of output data to the output buffer 128 and, after that, stops the operation. After the three pieces of output data are transferred to the output buffer 128, the output buffer 128 burst-transfers the three pieces of output data to the memory 121. The three pieces of output data transferred to the memory 121 are supplied to the interface S/W 112 at output events generated at the following times t2, t3, and t4 and transferred to the simulation S/W 111.

### Effects of Third Embodiment

As described above, according to the third embodiment, as the output buffer 128 is added in the interface part of the arithmetic device 124, a plurality of pieces of output data can be temporarily stored in the output buffer 128 and transferred from the output buffer 128 to the memory 121. Consequently, when the input time unit of the simulation S/W 111 is longer than the output time unit, the plurality of pieces of output data are burst-transferred in a lump from the output buffer 128 to the memory 121.

By the above, the number of times that the process of transferring input data from the simulation S/W 111 and the process of transferring input data to the hardware I/F 123 compete in the memory 121 decreases. As a result, the number of times that the process of the simulation S/W 111 delays can be decreased, so that the process time of the HIL simulation system 1A as a whole can be further shortened.

Although the present invention achieved by the inventors herein has been concretely described above on the basis of the embodiments, obviously, the present invention is not limited to the foregoing embodiments but can be variously changed without departing from the gist.

For example, although the second and third embodiments have been described as different embodiments, the second and third embodiments may be combined.

What is claimed is:

1. An HIL simulation system comprising:
a memory;
an arithmetic device executing an input process of receiving input data transferred from software to the memory from the memory and an output process of transferring output data to the memory;
a designating unit designating an operation state indicating the number of times of the output process to the number of times of the input process of the arithmetic device on the basis of an input time unit as an interval in which the software transfers input data to the memory and an output time unit as an interval in which the software receives output data transferred from the arithmetic device to the memory from the memory, and
a control unit controlling the number of times of the input process and the output process of the arithmetic device on the basis of the operation state designated by the designating unit and controlling stop of the operation of the arithmetic device.

2. The HIL simulation system according to claim 1,
wherein when the ratio between the input time unit and the output time unit of the software is N:1 (N is a natural number of two or larger), the designating unit designates the operation state that the ratio between the number of times of the input process and the number of times of the output process of the arithmetic device is 1:N.

3. The HIL simulation system according to claim 2,
wherein when the operation state designated by the designating unit is 1:N, the control unit makes the arithmetic device execute the output process N times subsequent to the input process of once.

4. The HIL simulation system according to claim 3,
wherein when the operation state designated by the designating unit is 1:N, the control unit makes the arithmetic device execute the output process N times subsequent to the input process of once and, after that, stops operation of the arithmetic device.

5. The HIL simulation system according to claim 4, further comprising an output buffer,
wherein in the output process, the arithmetic device transfers output data to the output buffer, and
wherein when the operation state designated by the designating unit is 1:N, after N pieces of output data are transferred to the output buffer by N times of the output process by the arithmetic device, the output buffer burst-transfers the N pieces of output data in a lump to the memory.

6. The HIL simulation system according to claim 1,
wherein when the ratio between the input time unit and the output time unit of the software is 1:N (N is a natural number of two or larger), the designating unit designates the operation state that the ratio between the number of times of the input process and the number of times of the output process of the arithmetic device is N:1.

7. The HIL simulation system according to claim 6,
wherein when the operation state designated by the designating unit is N:1, the control unit makes the arithmetic device execute the input process N times subsequent to the output process of once.

8. The HIL simulation system according to claim 7,
wherein when the operation state designated by the designating unit is N:1, the control unit stops the operation of the arithmetic device each time the output process and the input processes of the first time to the (N−1)th time are executed.

9. The HIL simulation system according to claim 8, further comprising:
an input buffer; and
a transfer unit, when the ratio between the input time unit and the output time unit of the software is 1:N, after N pieces of input data are transferred to the memory by the software, burst-transferring the N pieces of input data in a lump to the arithmetic device,
wherein the arithmetic device temporarily stores the N pieces of input data into the input buffer and, in the input process, receives input data from the input buffer.

10. A control method of an HIL simulation system comprising a memory and an arithmetic device executing an input process of receiving input data transferred from software to the memory from the memory and an output process of transferring output data to the memory, comprising the steps of:
designating an operation state indicating the number of times of the output process to the number of times of the input process of the arithmetic device on the basis of an input time unit as an interval in which the software transfers input data to the memory and an output time unit as an interval in which the software receives output data transferred from the arithmetic device to the memory from the memory, and
on the basis of the designated operation state, controlling the number of times of the input process and the output process of the arithmetic device, and controlling stop of the operation of the arithmetic device.
